(19) United States
(12) Patent Application Publication
(10) Pub. No.: US 2014/0195457 A1
(43) Pub. Date: Jul. 10, 2014

(54) LOAD BOARD WITH DATA AUTHENTICITY AND VIRTUAL COMMUNITIES

(71) Applicant: Trakkx.com, LLC, Kingsburg, CA (US)

(72) Inventor: John LOZITO, Encinitas, CA (US)

(21) Appl. No.: 13/830,215

(22) Filed: Mar. 14, 2013

Related U.S. Application Data
(60) Provisional application No. 61/749,143, filed on Jan. 4, 2013.

(51) Int. Cl. G06Q 10/08

(52) U.S. Cl. CPC G06Q 10/0834
USPC 705/334

(57) ABSTRACT

Freight transport load board platforms, systems, and applications comprising: a software module configured to allow creation of an availability post, the availability post comprising freight transport equipment information or freight information; a software module configured to allow creation of an order, the order comprising freight transport equipment information associated with freight information; and a software module configured to provide a user console display, the display comprising availability posts and orders; provided that the freight transport equipment information comprises information derived directly and automatically from an electronic device physically connected to the freight transport equipment, including methods of using the same.

### CROSS-REFERENCE TO RELATED APPLICATIONS

This application claims the benefit of U.S. Application Ser. No. 61/749,143, filed Jan. 4, 2013, which is hereby incorporated by reference in its entirety.

### BACKGROUND OF THE INVENTION

The Federal Bureau of Transportation Statistics reports that approximately 20 billion tons of freight is transported in the U.S. each year. Freight is transported via truck, rail, water, air, and other modes, with the majority being transported by truck. The trucking industry involves the transport and distribution of commercial and industrial goods using commercial motor vehicles; usually semi trucks, box trucks, or dump trucks. The trucking industry provides an essential service to the American economy by transporting large quantities of raw materials, works in process, and finished goods over land—typically from manufacturing plants to retail distribution centers.

### SUMMARY OF THE INVENTION

Freight posting services (also called freight matching services or load boards) are used by those with freight requiring transport and those with freight transport equipment for hire to coordinate and match freight to equipment. Before widespread use of Internet communications, truck drivers seeking loads left handwritten notes on physical bulletin boards at truck stops for shippers and freight brokers seeking truckers to move their freight. More recently, electronic bulletin boards are utilized for posting freight and available equipment.

Existing load boards fail to provide features to ensure data authenticity and integrity. Traditionally, all the data in a load board is user-entered and user-maintained without sufficient verification. As such, current implementations are plagued by stale, false, and even malicious entries. Moreover, existing load boards fail to leverage the relationships formed between trusted parties in the freight transport industry to further improve the reliability and usefulness of load boards.

Advantages of the platforms, systems, applications, and methods described herein include, but are not limited to, providing load boards with improved data authenticity and integrity and virtual communities. More specifically, the platforms, systems, applications, and methods described herein provide load boards wherein equipment availability posts include data generated and automatically entered into the system by electronic tracking devices affixed to the freight transport equipment without user intervention (e.g., machine-to-machine or M2M). Higher data quality and the compilation and analysis of historic data allows for levels of authenticity to be assigned to particular posts and users. Additional advantages include establishment of virtual communities that allow shippers, brokers, and operators to crate matches within their circle of partners before extending posts to the larger population of users.

In one aspect, disclosed herein are computer-implemented methods comprising the steps of: monitoring, by a processor, a plurality of activities in an environment for providing freight transportation information; storing, by the processor, the plurality of activities in a database; generating, by the processor, a feed of the activities, the feed for presentation to at least one viewing user and relating to one or more activities performed by another user; limiting access, by the processor, to the feed to provide a set of viewing users; and displaying, by the processor, the feed to at least one viewing user of the set of viewing users. In some embodiments, the environment for providing freight transportation information comprises: a transportation management system, a procurement system, or a load board. In some embodiments, the activities comprise posts indicating the availability of freight transport equipment. In some embodiments, the posts indicating the availability of freight transport equipment comprise freight transport equipment information derived directly and automatically from an electronic device physically connected to the freight transport equipment. In some embodiments, the activities comprise posts indicating the availability of freight. In some embodiments, the activities comprise orders indicating an association of freight transport equipment with freight. In further embodiments, the orders comprise freight transport equipment information derived directly and automatically from an electronic device physically connected to the freight transport equipment. In some embodiments, limiting access is based on the existence of a partnership between the performing user and the viewing user. In further embodiments, a partnership is created by an electronic request triggered by a first user followed by an acknowledgement to the request triggered by a second user. In further embodiments, a partnership is between one or more of: a shipper, a carrier, a broker, a transport equipment owner, a transport equipment operator, a receiver, an insurer, and a factoring company. In further embodiments, access to the feed of activities is permanently limited to the predetermined set of viewing users. In further embodiments, access to the feed of activities is temporarily limited to the predetermined set of viewing users. In still further embodiments, access to each activity in the feed of activities is unlimited after a delay period. In still further embodiments, the delay period is at least 1 minute, 5 minutes, 10 minutes, 15 minutes, 30 minutes, 1 hour, 2 hours, 3 hours, 6 hours, 12 hours, 1 day, 2 days, or 3 days. In some embodiments, the delay period is user configurable.

In another aspect, disclosed herein are non-transitory computer-readable storage media encoded with a computer program including instructions executable by a processor to create a load board application, the application comprising: a software module configured to allow creation of an availability post, the availability post comprising freight transport equipment information or freight information; a software module configured to allow creation of an order, the order comprising freight transport equipment information associated with freight information; and a software module configured to provide a user console display, the display comprising availability posts and orders; provided that the freight transport equipment information comprises information derived directly and automatically from an electronic device physically connected to the freight transport equipment. In some embodiments, the electronic device physically connected to the freight transport equipment comprises a GPS chip and cellular modem. In some embodiments, the freight transport equipment is a: tractor, trailer, shipping container, rail car, aircraft, or watercraft. In some embodiments, the freight transport equipment information comprises: location and load status. In further embodiments, the freight transport equipment information comprises: type of freight transport equipment, operator, and carrier. In some embodiments, the freight information comprises: description of the freight, pick-up location, pick-up date and time, drop-off location, and drop-off date and time. In further embodiments, the freight information comprises: suitable type of freight transport equipment and suitable transport environmental conditions. In some embodiments, each order displayed by the user console display comprises freight transport equipment information including one or more of: telemetry information and freight integrity information. In further embodiments, the telemetry information comprises at least one of: location, speed, direction, and altitude. In still further embodiments, the telemetry information is displayed on a map. In still further embodiments, the telemetry information is displayed as a breadcrumb trail on the map. In some embodiments, the user console display comprises tools to sort or filter availability posts and orders. In further embodiments, the sorting or filtering is based on one or more of: type of freight transport equipment, freight transport equipment location, freight transport equipment status, operator, carrier, type of freight, freight pick-up location, freight pick-up date and time, freight drop-off location, and freight drop-off date and time. In some embodiments, the application further comprises a software module configured to allow creation of partnerships between users, a partnership created by an electronic request followed by an acknowledgement. In further embodiments, a partnership is between one or more of: a shipper, a carrier, a broker, a transport equipment owner, a transport equipment operator, a receiver, an insurer, and a factoring company. In further embodiments, the user console display comprises tools to sort or filter availability posts and orders based on one or more created partnerships. In further embodiments, created availability posts are optionally displayed first to partners and subsequently to non-partners after passage of a delay period. In still further embodiments, the delay period is configurable by a user. In some embodiments, the module configured to allow creation of an availability post assigns a level of data authenticity. In further embodiments, the level of data authenticity is based on method of installation of the electronic device physically connected to the freight transport equipment. In further embodiments, the level of data authenticity is based on last inspection date for the electronic device physically connected to the freight transport equipment. In further embodiments, the level of data authenticity is based on one or more of: user ratings, user reviews, and credit score. In some embodiments, the application further comprises a software module configured to search freight transport equipment information of availability posts. In some embodiments, the application further comprises a software module configured to search freight information of availability posts. In some embodiments, the application further comprises a software module configured to predict future availability of freight transport equipment based on current orders. In further embodiments, the future availability of freight transport equipment is predicted from 1 hour to 24 hours in the future. In further embodiments, the future availability of freight transport equipment is predicted from 1 day to 14 days in the future. In some embodiments, the software module configured to predict future availability of freight transport equipment based on current orders is operated by a slider GUI element on the user console display. In some embodiments, the load board application is a web application. In further embodiments, the load board application is provided as software-as-a-service. In other embodiments, the load board application is a mobile application.

In another aspect, disclosed herein are computer-implemented systems comprising: a digital processing device comprising an operating system configured to perform executable instructions and a memory device; and a computer program including instructions executable by the digital processing device to create a load board application, the application comprising: a software module configured to allow creation of an availability post, the availability post comprising freight transport equipment information or freight information; a software module configured to allow creation of an order, the order comprising freight transport equipment information associated with freight information; and a software module configured to provide a user console display, the display comprising availability posts and orders; provided that the freight transport equipment information comprises information derived directly and automatically from an electronic device physically connected to the freight transport equipment. In some embodiments, the electronic device physically connected to the freight transport equipment comprises a GPS chip and cellular modem. In some embodiments, the freight transport equipment is a: tractor, trailer, shipping container, rail car, aircraft, or watercraft. In some embodiments, the freight transport equipment information comprises: location and load status. In further embodiments, the freight transport equipment information comprises: type of freight transport equipment, operator, and carrier. In some embodiments, the freight information comprises: description of the freight, pick-up location, pick-up date and time, drop-off location, and drop-off date and time. In further embodiments, the freight information comprises: suitable type of freight transport equipment and suitable transport environmental conditions. In some embodiments, each order displayed by the user console display comprises freight transport equipment information including one or more of: telemetry information and freight integrity information. In further embodiments, the telemetry information comprises at least one of: location, speed, direction, and altitude. In still further embodiments, the telemetry information is displayed on a map. In still further embodiments, the telemetry information is displayed as a breadcrumb trail on the map. In some embodiments, the user console display comprises tools to sort or filter availability posts and orders. In further embodiments, the sorting or filtering is based on one or more of: type of freight transport equipment, freight transport equipment location, freight transport equipment status, operator, carrier, type of freight, freight pick-up location, freight pick-up date and time, freight drop-off location, and freight drop-off date and time. In some embodiments, the application further comprises a software module configured to allow creation of partnerships between users, a partnership created by an electronic request followed by an acknowledgement. In further embodiments, a partnership is between one or more of: a shipper, a carrier, a broker, a transport equipment owner, a transport equipment operator, a receiver, an insurer, and a factoring company. In further embodiments, the user console display comprises tools to sort or filter availability posts and orders based on one or more created partnerships. In further embodiments, created availability posts are optionally displayed first to partners and subsequently to non-partners after passage of a delay period. In still further embodiments, the delay period is configurable by a user. In some embodiments, the module configured to allow creation of an availability post assigns a level of data authenticity. In further embodiments, the level of data authenticity is based on method of installation of the electronic device physically connected to the freight transport equipment. In further embodiments, the level of data authenticity is based on last inspection date for the electronic device physically connected to the freight transport equipment. In further embodiments, the level of data authenticity is based on one or more of: user ratings, user reviews, and credit score. In some embodiments, the application further comprises a software module configured to search freight transport equipment information of availability posts. In some embodiments, the application further comprises a software module configured to search freight information of availability posts. In some embodiments, the application further comprises a software module configured to predict future availability of freight transport equipment based on current orders. In further embodiments, the future availability of freight transport equipment is predicted from 1 hour to 24 hours in the future. In further embodiments, the future availability of freight transport equipment is predicted from 1 day to 14 days in the future. In some embodiments, the software module configured to predict future availability of freight transport equipment based on current orders is operated by a slider GUI element on the user console display. In some embodiments, the load board application is a web application. In further embodiments, the load board application is provided as software-as-a-service. In other embodiments, the load board application is a mobile application.

In another aspect, disclosed herein are data authenticated load board platforms comprising: a plurality of electronic devices, each device physically connected to a piece of freight transport equipment, each device configured to transmit freight transport equipment information to a load board application; and a server comprising a processor configured to provide a load board application, the application comprising: a software module configured to allow creation of an availability post, the availability post comprising the transmitted freight transport equipment information or freight information; a software module configured to allow creation of an order, the order comprising the transmitted freight transport equipment information associated with freight information; and a software module configured to provide a user console display, the display comprising availability posts and orders.

### BRIEF DESCRIPTION OF THE DRAWINGS

FIG. 1 shows a non-limiting example of an electronic device for generating and wirelessly transmitting freight transport equipment information; in this case, a device including a hardened protective case with attachment points to facilitate securing the device to freight transport equipment.

FIG. 2 shows a non-limiting exemplary schematic diagram of an electronic device for generating and wirelessly transmitting freight transport equipment information; in this case, a device including a processor, power sources, a GPS module, a GSM module, an accelerometer module, and input/output for a plurality of sensors.

FIG. 3 shows a non-limiting example of a user console display; in this case, a display including a plurality of orders. For each order, the display includes a party to be billed, a pick-up date, a driver, a carrier, an origination city, an origination state, a destination city, a destination state, a description of the freight, weight of the freight, purchase order numbers, a delivery date, a current location, and a load status.

FIG. 4 shows a non-limiting example of a user console display; in this case, a display including an order detail summary.

FIG. 5 shows a non-limiting example of a user console display; in this case, a display including telemetry data displayed on a map as a breadcrumb trail for a particular order.

FIG. 6 shows a non-limiting example of a user console display; in this case, a display including telemetry data graphed over time.

FIG. 7 shows a non-limiting example of a user console display; in this case, a display including an order check-call tracking summary.

FIG. 8 shows a non-limiting example of a user console display; in this case, a display including a feature for entering new order information.

FIG. 9 shows a non-limiting example of a user console display; in this case, a display including a feature for entering pickup and delivery information for a new order.

FIG. 10 shows a non-limiting example of a user console display; in this case, a display including a feature for entering accounts receivable and accounts payable information for a new order.

FIG. 11 shows a non-limiting example of a user console display; in this case, a display including a feature for entering carrier and equipment information for a new order.

FIG. 12 shows a non-limiting example of a user console display; in this case, a display including a feature for configuring alarms for a new order.

FIG. 13 shows a non-limiting example of a user console display; in this case, a display including a feature for entering load sharing information for a new order.

FIG. 14 shows a non-limiting example of a user console display; in this case, a display including telemetry data displayed on a map as a breadcrumb trail for a plurality of orders.

FIG. 15 shows a non-limiting example of an administrative console for managing partnerships; in this case, a console including tools for viewing permissions allowing partners to view posted orders (e.g., availability posts or created orders) or assets (e.g., freight transport equipment) and/or permissions for partners to be shown posted orders or assets.

FIG. 16 shows a non-limiting example of an administrative console for managing partnerships; in this case, a console including tools for filtering partners based on type, ID, or order/asset sharing status.

FIG. 17 shows a non-limiting example of an administrative console for managing partnerships; in this case, a console including tools for configuring permissions allowing a partner to view posted orders or assets (e.g., freight transport equipment) and/or permissions for a partner to be shown posted orders or assets.

FIG. 18 shows a non-limiting example of an administrative console for managing partnerships; in this case, a console including tools for configuring orders to be viewed from a particular partner.

FIG. 19 shows a non-limiting example of an administrative console for managing partnerships; in this case, a console including tools for configuring assets (e.g., freight transport equipment) to be viewed from a particular partner.

FIG. 20 shows a non-limiting example of an administrative console for managing partnerships; in this case, a console including tools for configuring orders to be shown to a particular partner.

FIG. 21 shows a non-limiting example of an administrative console for managing partnerships; in this case, a console including tools for configuring assets (e.g., freight transport equipment) to be shown to a particular partner.

FIG. 22 shows a non-limiting example of an administrative console for managing partnerships; in this case, a console including tools to customize a user's partnership profile.

### DETAILED DESCRIPTION OF THE INVENTION

Current load board technologies fail to adequately authenticate data entered into posts resulting in stale, inaccurate, and potentially malicious entries. Additionally, existing load boards fail to provide for establishment of virtual communities of trusted partners.

Described herein, in certain embodiments, are computer-implemented methods comprising the steps of: monitoring, by a processor, a plurality of activities in an environment for providing freight transportation information; storing, by the processor, the plurality of activities in a database; generating, by the processor, a feed of the activities, the feed for presentation to at least one viewing user and relating to one or more activities performed by another user; limiting access, by the processor, to the feed to provide a set of viewing users; and displaying, by the processor, the feed to at least one viewing user of the set of viewing users.

Also described herein, in certain embodiments, are non-transitory computer-readable storage media encoded with a computer program including instructions executable by a processor to create a load board application, the application comprising: a software module configured to allow creation of an availability post, the availability post comprising freight transport equipment information or freight information; a software module configured to allow creation of an order, the order comprising freight transport equipment information associated with freight information; and a software module configured to provide a user console display, the display comprising availability posts and orders; provided that the freight transport equipment information comprises information derived directly and automatically from an electronic device physically connected to the freight transport equipment.

Also described herein, in certain embodiments, are computer-implemented systems comprising: a digital processing device comprising an operating system configured to perform executable instructions and a memory device; and a computer program including instructions executable by the digital processing device to create a load board application, the application comprising: a software module configured to allow creation of an availability post, the availability post comprising freight transport equipment information or freight information; a software module configured to allow creation of an order, the order comprising freight transport equipment information associated with freight information; and a software module configured to provide a user console display, the display comprising availability posts and orders; provided that the freight transport equipment information comprises information derived directly and automatically from an electronic device physically connected to the freight transport equipment.

Also described herein, in certain embodiments, are data authenticated load board platforms comprising: a plurality of electronic devices, each device physically connected to a piece of freight transport equipment, each device configured to transmit freight transport equipment information to a load board application; and a server comprising a processor configured to provide a load board application, the application comprising: a software module configured to allow creation of an availability post, the availability post comprising the transmitted freight transport equipment information or freight information; a software module configured to allow creation of an order, the order comprising the transmitted freight transport equipment information associated with freight information; and a software module configured to provide a user console display, the display comprising availability posts and orders.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Freight Transport Equipment

In some embodiments, the platforms, systems, applications, and methods described herein include freight transport equipment, or use of the same. In some embodiments, the systems, devices, software, and methods described herein include a device attached to freight transport equipment, or use of the same. In further embodiments, a device attached to freight transport equipment is configured to transmit freight transport equipment information.

Many types of freight transport equipment are suitable. in various embodiments, suitable freight transport equipment includes, by way of non-limiting examples, automobiles, tractors, trailers, shipping containers, rail cars, aircraft, watercraft, and the like. In some embodiments, suitable freight transport equipment includes automobiles such as cars, trucks, tow trucks, vans, busses, etc. In some embodiments, suitable freight transport equipment includes tractors such as semi-tractors, semi-trailer trucks, transfer trucks, articulated vehicles, dump trucks, logging trucks, tank trucks, refrigerated trucks, road trains, auto transport trucks, etc. In some embodiments, suitable freight transport equipment includes trailers such as semi-trailers, box trailers, dry bulk trailers, refrigerated trailers, bus trailers, tank trailers, dump trailers, auto transport trailers, flatbed trailers, single trailers, multiple (e.g., double, triple, stacked, etc.), and the like. In some embodiments, suitable freight transport equipment includes shipping containers such as intermodal freight containers, boxes (including wooden boxes), corrugated boxes (including fiberboard boxes), crates, intermediate bulk shipping containers, intermediate bulk containers, flexible intermediate bulk containers, bulk boxes, drums (including steel drums), insulated shipping containers, etc. In some embodiments, suitable freight transport equipment includes rail cars such as auto racks, box cars, center beam cars, flat cars, well cars, gondolas, hoppers, lorries, open wagons, refrigerator cars, side dump cars, spine cars, stock cards, tank cars, Schnabel cars, etc. In some embodiments, suitable freight transport equipment includes aircraft such as propeller aircraft, jet aircraft, rotorcraft, gliders, blimps, balloons, etc. In some embodiments, suitable freight transport equipment includes watercraft such as airboat, barge, sailboat, cabin cruiser, cargo ship, catamaran, cruise ship, fishing boat, hovercraft, hydrofoil, hydroplane, ice boat, jet boat, pontoon boat, ferry, submarine, tanker, tug boat, etc. In some embodiments, manned and/or unmanned freight transport equipment is suitable.

### Device

In some embodiments, the platforms, systems, applications, and methods described herein include an electronic device physically connected to (or integrated with) freight transport equipment, or use of the same. In some embodiments, the electronic device generates freight transport equipment information and transmits it to the platforms, systems, and applications described herein.

Many mechanisms of attachment are suitable. In various embodiments, a device is attached to freight transport equipment by, for example, fasteners, adhesives, welds, and the like. In some embodiments, a mechanism of attachment prevents tampering of the device or removal of the device from the freight transport equipment. In further embodiments, a device has a rugged, reinforced, or armored case and is attached to freight transport equipment via a permanent, substantially permanent, or semi-permanent mechanism.

In some embodiments, a device attached to freight transport equipment is configured to transmit freight transport equipment information described further herein. In some embodiments, a device attached to freight transport equipment and configured to transmit freight transport equipment information is a digital processing device comprising a processor. In some embodiments, a device attached to freight transport equipment and configured to transmit freight transport equipment information includes a power source. In various embodiments, a suitable power source is a power line in from the freight transport equipment, a battery (e.g., zinc-carbon (ZnC), alkaline, nickel-cadmium (NiCd), nickel-zinc (NiZn), nickel metal hydride (NiMH), lithium-ion (Li-ion), etc.), or both. In some embodiments, a device attached to freight transport equipment and configured to transmit freight transport equipment information includes a sensor input/output (I/O) element. In some embodiments, a device attached to freight transport equipment includes a location component. In further embodiments a device includes a GPS element to access a positioning system. In some embodiments, a device attached to freight transport equipment includes a communications component. In further embodiments a device includes a telecommunications element (e.g., GSM or similar) to communicate with a cellular phone network.

In some embodiments, a device attached to freight transport equipment transmits freight transport equipment information on a continuous or substantially continuous basis. In other embodiments, a device attached to freight transport equipment transmits information on a periodic basis. Many transmission periods are suitable. In further embodiments, a device attached to freight transport equipment stores information and transmits the information if and when a suitable communication channel becomes available. For example, a device utilizing a cellular radio to transmit information and attached to an aircraft or to freight in an aircraft may not be able to transmit information during portions of the transport. In such cases, a device optionally stores freight transport equipment information, freight integrity information, and/or operator biometric information in a memory device and transmits the information if and when a cellular network signal becomes available.

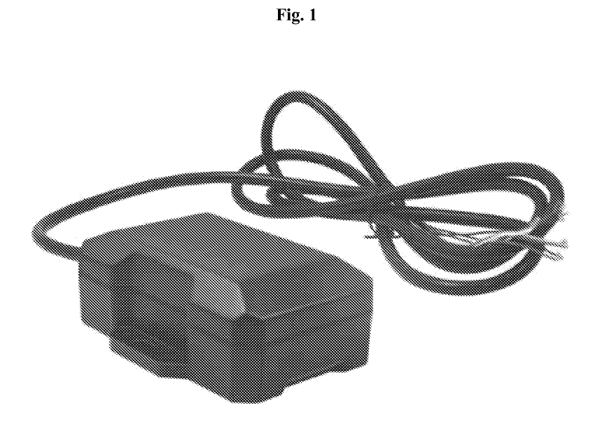

Referring to FIG. 1, in a particular embodiment, a device is suitable for attachment to freight transport equipment and is configured to transmit freight transport equipment information. In this embodiment, the device includes a hard plastic case with features to facilitate attachment.

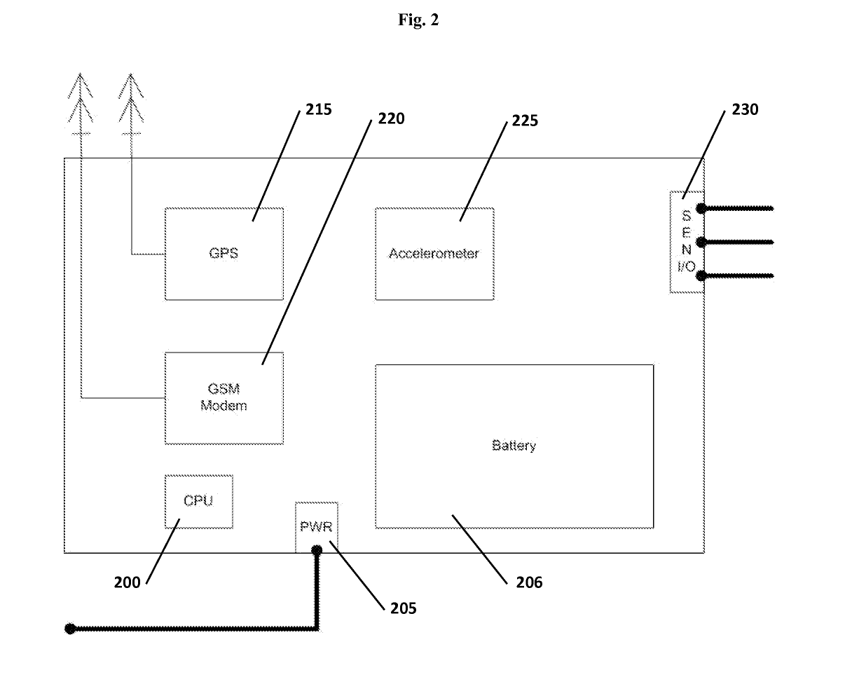

Referring to FIG. 2, in a particular embodiment, a device is suitable for attachment to freight transport equipment and is configured to transmit freight transport equipment information. In this embodiment, the device includes a central processing unit (CPU) 200 and both a line in 205 and a battery 206 to provide power. Further in this embodiment, the device includes a GPS module 215 with an antenna to access a positioning system and a GSM module 220, also with an antenna to communicate with a cellular phone network. The device in this embodiment further includes sensor elements such as an accelerometer module 225 and in input/output element 230 for a network of sensors.

A device is optionally attached to freight transport equipment by a number of suitable parties. In some embodiments, a device is attached to freight transport equipment by a shipper, a carrier, a broker, an operator, a receiver, or an equipment owner. In other embodiments, a device is attached to freight transport equipment by a third party provider of the systems, devices, software, and methods described herein. In some embodiments, the quality and/or reliability of freight transport equipment information transmitted by a device is determined, at least in part, by the party attaching the device to freight transport equipment.

A device (attached to freight transport equipment) is optionally inspected at one or more time points by a number of suitable parties. In various embodiments, a device is suitably inspected for, by way of non-limiting examples, integrity, attachment, tampering, and the like. In some embodiments, a device is inspected by a shipper, a carrier, a broker, an operator, a receiver, or an equipment owner. In other embodiments, a device is inspected by a third party provider of the systems, devices, software, and methods described herein. A device is suitably inspected at a variety of time points and/or time intervals. In some embodiments, a device is inspected at one or more key points in freight transport, including, by way of non-limiting examples, pickup, a way point, drop off, and the like. In some embodiments, a device is inspected periodically. In various further embodiments, a device is inspected yearly, semi-yearly, quarterly, month, semi-monthly, weekly, daily, and hourly, including increments therein. In some embodiments, the quality and/or reliability of freight transport equipment information transmitted by a device is determined, at least in part, by the party inspecting the device, the time point(s) of inspection, and/or the time interval between inspections.

### Freight Transport Equipment Information

In some embodiments, the platforms, systems, applications, and methods described herein include freight transport equipment information, or use of the same. In further embodiments, freight transport equipment information is included in a load board availability post (e.g., a post indicating equipment available to transport freight). In still further embodiments, a load board order comprises freight transport equipment information paired with freight information.

Many types of freight transport equipment information are suitable. In various embodiments, suitable freight transport equipment information includes, by way of non-limiting examples, freight transport equipment type (e.g., reefer, flatbed, tanker, auto transport, van, etc.), freight transport equipment operator (e.g., driver), freight transport equipment carrier (e.g., operating authority the equipment is operated under), freight transport equipment location information, freight transport equipment status information, freight integrity information, and the like.

In some embodiments, suitable freight transport equipment information includes location information. In further embodiments, location information includes telemetry information. In still further embodiments, telemetry information includes, by way of non-limiting examples, location (e.g., latitude/longitude, street address, intersection, distance to a landmark, position on a map, etc.), speed, direction (e.g., heading, etc.), and altitude. In still further embodiments, telemetry information is graphed and/or charted over time to illustrate, for example, location, speed, and/or altitude over the course of transport.

In some embodiments, suitable freight transport equipment information includes equipment status information, optionally including load status. In further embodiments, freight transport equipment status information indicates whether freight is loaded or not. In further embodiments, freight transport equipment status information indicates whether freight transport equipment has departed or reached a particular location (e.g., a pickup, a drop off, a waypoint, etc.). In further embodiments, freight transport equipment status information indicates whether freight transport equipment is busy or available. In still further embodiments, freight transport equipment status information includes, by way of non-limiting examples, available, booked, dispatched, arrived at pick up, loaded, arrived at drop off, dropped, and empty.

In some embodiments, suitable freight transport equipment information includes freight integrity information. In further embodiments, freight integrity information indicates the conditions that freight is exposed to during transport. In still further embodiments, freight integrity information indicates whether freight is exposed to conditions beyond certain thresholds during transport. In still further embodiments, freight integrity information indicates whether freight is accessed, stolen, tampered with, or adulterated during transport. In some embodiments, freight integrity information includes, by way of non-limiting examples, temperature, humidity, atmospheric pressure, vibration, shock, and ambient light. In some embodiments, freight integrity information includes, door status (e.g., unopened, opened, opened a particular number of times, opened for a particular time period, etc.). In still further embodiments, freight integrity information is graphed and/or charted over time to illustrate, for example, temperature, humidity, atmospheric pressure, shock and/or vibration over the course of transport.

In some embodiments, freight integrity information is verified through the recording and uploading of audio and/or still or video imagery. For example, in further embodiments, one or more still or video cameras capture photographic documentation of the integrity of the freight at one or more time points (including at regular periodic intervals). Suitable photographic documentation includes, by way of non-limiting examples, images of freight captured by one or more cameras located in the freight transport compartment of the freight transport equipment, images of the freight transport equipment captured by one or more cameras located on the exterior of the equipment, and images of the area surrounding the freight transport equipment captured by one or more cameras located on the exterior of the equipment.

In view of the disclosure provided herein, those of skill in the art will recognize that many databases are suitable for storage and retrieval of freight transport equipment information, including any of the databases described herein.

### Freight Information

In some embodiments, the platforms, systems, applications, and methods described herein include freight information, or use of the same. In further embodiments, freight information is included in a load board availability post (e.g., a post indicating freight in need of transport). In still further embodiments, a load board order comprises freight transport equipment information paired with freight information.

Many types of freight information are suitable. In various embodiments, suitable freight information includes, by way of non-limiting examples, description of the freight, pick-up location, pick-up date, pick-up time, drop-off location, drop-off date, drop-off time, suitable type(s) of freight transport equipment (e.g., tanker, flatbed, auto transport, etc.), suitable transport environmental conditions (e.g., temperature, humidity, atmospheric pressure, vibration, etc.), and the like.

In view of the disclosure provided herein, those of skill in the art will recognize that many databases are suitable for storage and retrieval of freight transport equipment information, including any of the databases described herein.

### Availability Posts

In some embodiments, the platforms, systems, applications, and methods described herein include one or more load board availability posts, or use of the same. In further embodiments, a user posts to a load board to notify other users of availability of freight in need of transport and/or availability freight transport equipment to haul freight. Many types of users suitably create availability posts. In various embodiments, suitable users include, by way of non-limiting examples, shippers, receivers, carriers, brokers, operators, freight transport equipment owners, and the like. In some embodiments, a load board is implemented as a web application and a user makes an availability post via a web-based interface accessed with a web browser.

In certain embodiments, a user posts availability of freight to a load board. In various embodiments, a post indicating freight available for transport includes, by way of non-limiting examples, the type of freight, a description of the freight, the weight of the freight, suitable type(s) of freight transport equipment, location of the freight, pick-up date, pick-up time, preferred transport route, drop-off date, drop-off time, environmental requirements to preserve the integrity of the freight, and the like. In some embodiments, a post indicating freight available for transport is configured to expire after a pre-determined period of time. In other embodiments, a post indicating freight available for transport is configured to expire on a pre-determined date and/or time.

In certain embodiments, a user posts availability of freight transport equipment to a load board. In various embodiments, a post indicating freight transport equipment available to haul freight includes, by way of non-limiting examples, the type of equipment, a description of the equipment, the hauling capacity of the equipment, location of the freight transport equipment, load status of the freight transport equipment, dates and times of availability, freight environmental conditions that the equipment is capable of maintaining (e.g., temperature, humidity, vibration, etc.), and the like. In some embodiments, a post indicating freight transport equipment available to haul freight is configured to expire after a pre-determined period of time. In other embodiments, a post indicating freight transport equipment available to haul freight is configured to expire on a pre-determined date and/or time.

In some embodiments, an availability post is presented to a particular user. In some embodiments, an availability post is presented to a particular group of users. In further embodiments, an availability post is first presented to a particular user or group of users and later presented to the entire population of users. In still further embodiments, an availability post is first presented to a particular user or group of users and later presented to the entire population of users on a pre-determined date/time or after a predetermined period of time. In other embodiments, an availability post is presented to all users.

In some embodiments, an availability post offers data authenticity and/or integrity. In further embodiments, data with authenticity and/or integrity is not user-generated and not entered by a user into the load board and is not easily susceptible to manipulation, falsification, or alteration. In further embodiments, an availability post offers data authenticity and/or integrity by including data generated by a tamper-resistant electronic device attached to the freight transport equipment. In still further embodiments, an availability post offers data authenticity and/or integrity by including data transmitted from a tamper-resistant electronic device attached to the freight transport equipment. In certain embodiments, a freight transport equipment availability post includes information generated and transmitted by an electronic device attached to the freight transport equipment. In further embodiments, the information is generated and transmitted directly and automatically by the electronic device. In still further embodiments, the information generated and transmitted by the electronic device includes, by way of non-limiting examples, identification of the equipment, location of the equipment, operator of the equipment, load status of the equipment, capabilities of the equipment and the like.

In some embodiments, an availability post offers data authenticity and/or integrity by including an authenticity score, ranking, or rating. In further embodiments, a data authenticity score, ranking, or rating reflects that some or all of the information in the post is not user-generated. In still further embodiments, an authenticity score, ranking, or rating reflects that some or all of the information in the post is generated and transmitted to the application by an electronic device without user intervention. In certain embodiments, a data authenticity score, ranking, or rating reflects, by way of non-limiting examples, the type of electronic device generating the data, the party who installed the device on the freight transport equipment, the last inspection date of the device, the party last inspecting the device, and the like.

In some embodiments, a data authenticity score, ranking, or rating reflects an analysis of previous activities by the posting user. In further embodiments, a data authenticity score, ranking, or rating reflects that the posting user has a history of making posts that include information with high data authenticity and/or integrity. In still further embodiments, an authenticity score, ranking, or rating reflects that the posting user has a history of making posts that include information generated and transmitted to the application by an electronic device without the user's intervention.

### Orders

In some embodiments, the platforms, systems, applications, and methods described herein include one or more load board orders, or use of the same. In further embodiments, an order comprises freight transport equipment information associated with freight information. In some embodiments, an order is formed when a party posting availability of freight forms an association with a posting indicated availability of freight transport equipment. In other embodiments, an order is formed when a party posting availability of freight transport equipment forms an association with a posting indicated availability of freight.

### User Console Display

In some embodiments, the platforms, systems, applications, and methods described herein include a software module configured to provide a user console display, or use of the same. In some embodiments, a user console displays availability posts including posts indicating availability of freight in need of transport and posts indicating freight transport equipment available to haul freight. In further embodiments, a user console displays freight information associated with freight transport equipment information (e.g., orders, etc.). In some embodiments, a user console displays a data authenticity score, rank, or rating in association with an availability post.

In some embodiments, a user console displays provides a continuously updated stream of user activity within a transportation management system, a procurement system, or a load board. In further embodiments, a user console displays provides activity feeds. In some embodiments, activities displayed in a feed are optionally limited. In further embodiments, activities displayed in a feed are limited based on user-configured filters. In further embodiments, activities displayed in a feed are limited based on time of posting, posting user, location of freight or freight transport equipment, type of freight or freight transport equipment. In certain embodiments, activities displayed in a feed are limited based on partnerships. In further embodiments, activities displayed in a feed are limited based on the existence of a partnership between the performing user and the viewing user.

In some embodiments, a user console display is intranet-based. In some embodiments, a user console display is internet-based. In further embodiments, a user console display is web-based. In still further embodiments, a user console display is cloud computing based. In some embodiments, a user console display is implemented as a web application and offered as software-as-a-service. In other embodiments, a user console display is implemented as a mobile application offered for purchase and download. In yet other embodiments, a user console display is implemented as a free mobile application available for download.

The information displayed by a user console described herein is updated at a wide range of suitable time intervals. In various embodiments, the information displayed by a user console described herein is updated, for example, at least every 12, 11, 10, 9, 8, 7, 6, 5, 4, 3, 2, 1, or less hours, including increments therein. In various further embodiments, the information displayed by a user console described herein is updated, for example, at least every 60, 55, 50, 45, 40, 35, 30, 25, 20, 15, 14, 13, 12, 11, 10, 9, 8, 7, 6, 5, 4, 3, 2, 1 or less minutes, including increments therein. In various further embodiments, the information displayed by a user console described herein is updated, for example, at least every 60, 55, 50, 45, 40, 35, 30, 25, 20, 15, 14, 13, 12, 11, 10, 9, 8, 7, 6, 5, 4, 3, 2, 1 or less seconds, including increments therein. In some embodiments, the information is updated continuously or substantially continuously such that the information is provided in real-time or substantially in real-time.

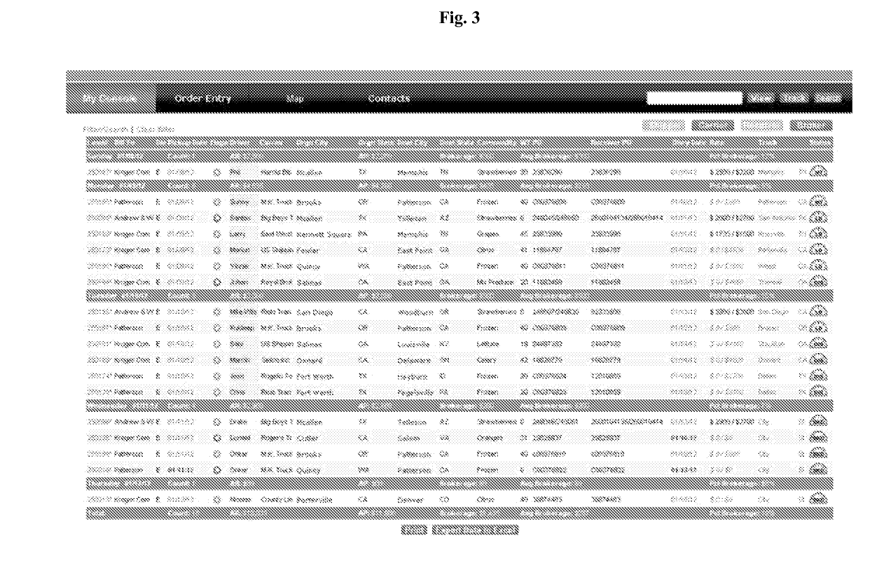

Referring to FIG. 3, in a particular embodiment, a user console display provides information on a plurality of orders. In this embodiment, for each order the display includes a party to be billed, a pick-up date, a driver, a carrier, an origination city, an origination state, a destination city, a destination state, a description of the freight, weight of the freight, purchase order numbers, a delivery date, a current location, and a load status.

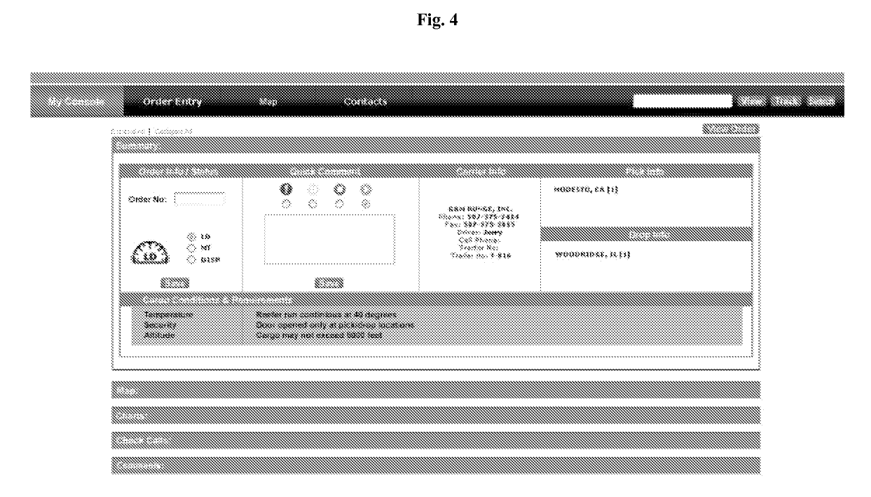

Referring to FIG. 4, in a particular embodiment, a user console display optionally provides an order detail summary for each order. In this embodiment, order details include order number, load status, comments, carrier information, pick-up information, drop-off information, and cargo conditions and requirements.

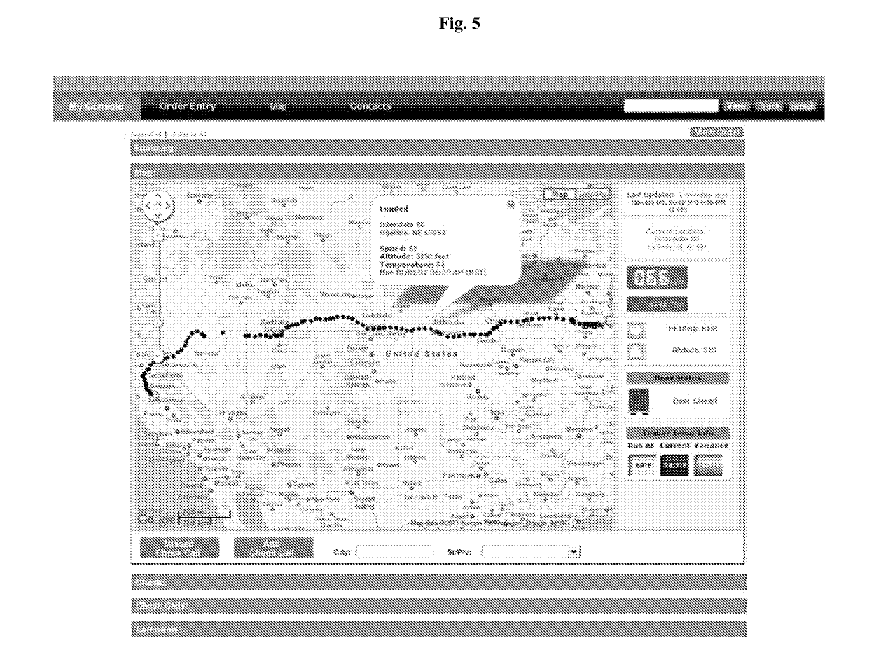

Referring to FIG. 5, in a particular embodiment, a user console display optionally provides an order detail summary for each order. In this embodiment, order details include telemetry data displayed on a map as a breadcrumb trail for a particular order, wherein each breadcrumb comprises telemetry data captured at a particular point in time.

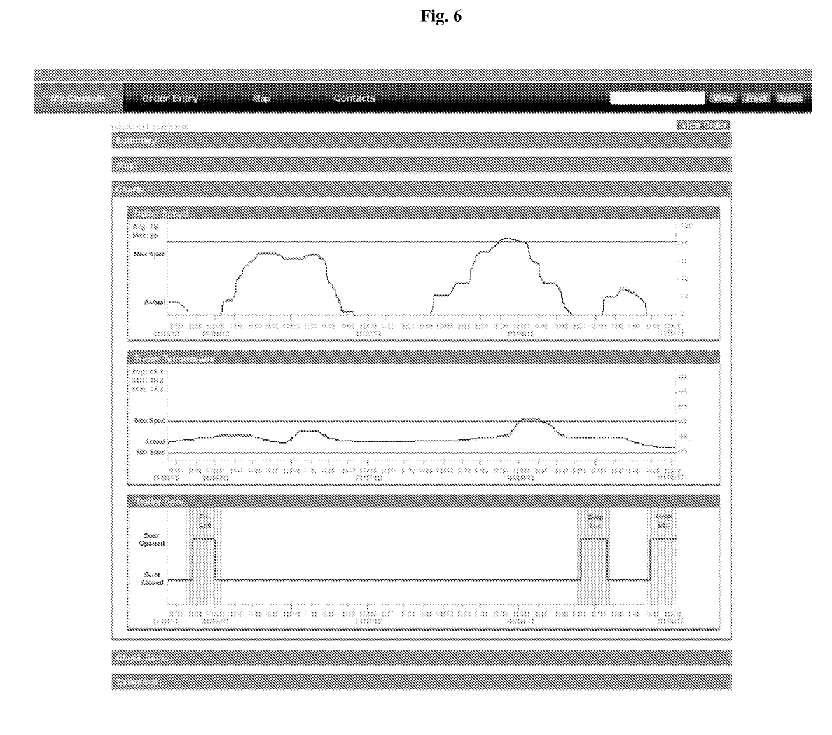

Referring to FIG. 6, in a particular embodiment, a user console display optionally provides an order detail summary for each order. In this embodiment, order details include telemetry data graphed over time to indicate variations in data such as speed, temperature, and door status over the course of hauling.

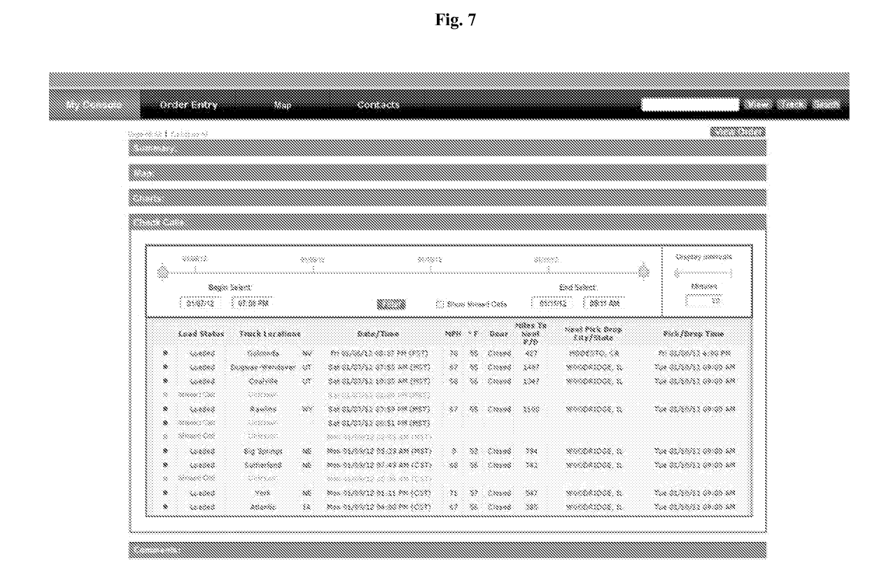

Referring to FIG. 7, in a particular embodiment, a user console display optionally provides an order detail summary for each order. In this embodiment, order details include order check-call tracking summary for a configurable time period, wherein the relevant time period is optionally adjusted using a slider GUI control.

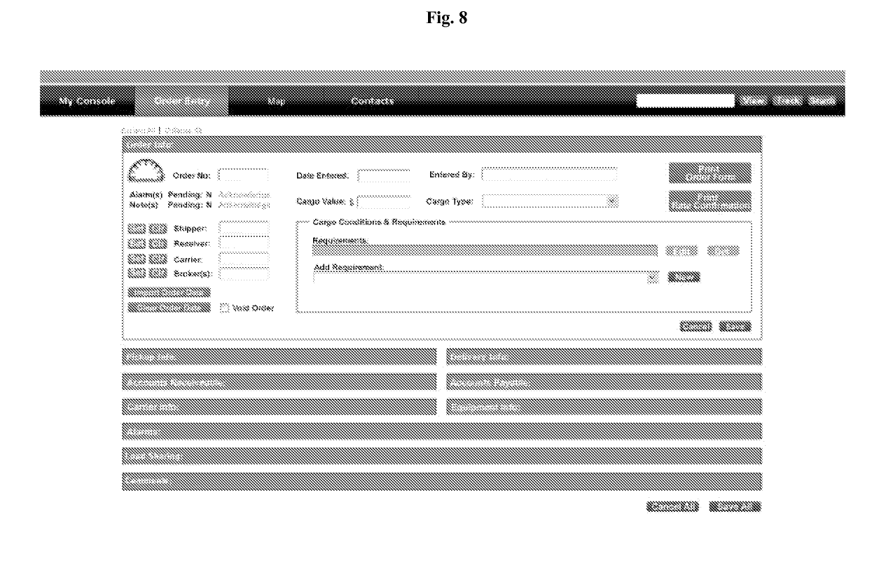

Referring to FIG. 8, in a particular embodiment, a user console display optionally provides tools for creation of a new order. In this embodiment, new order creation tools include a GUI for entering basic order information such as order number, date of entry, user entering the information, alarms, notes, cargo value, cargo type, shipper, receiver, carrier, brokers, cargo conditions and requirements, and the like.

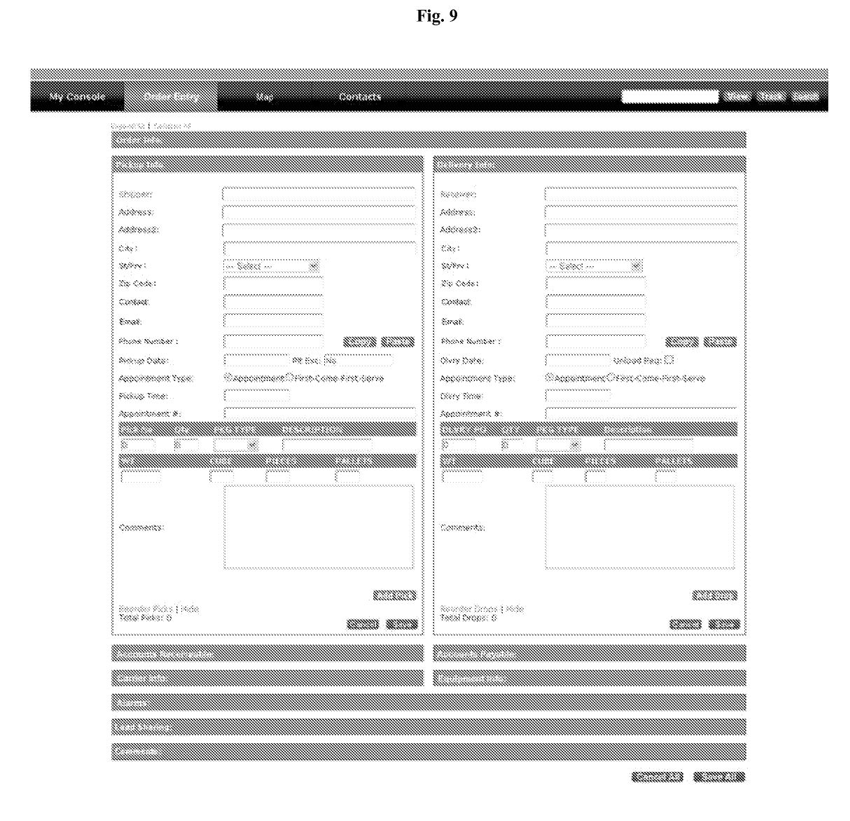

Referring to FIG. 9, in a particular embodiment, a user console display optionally provides tools for creation of a new order. In this embodiment, new order creation tools include a GUI for entering pickup and delivery information.

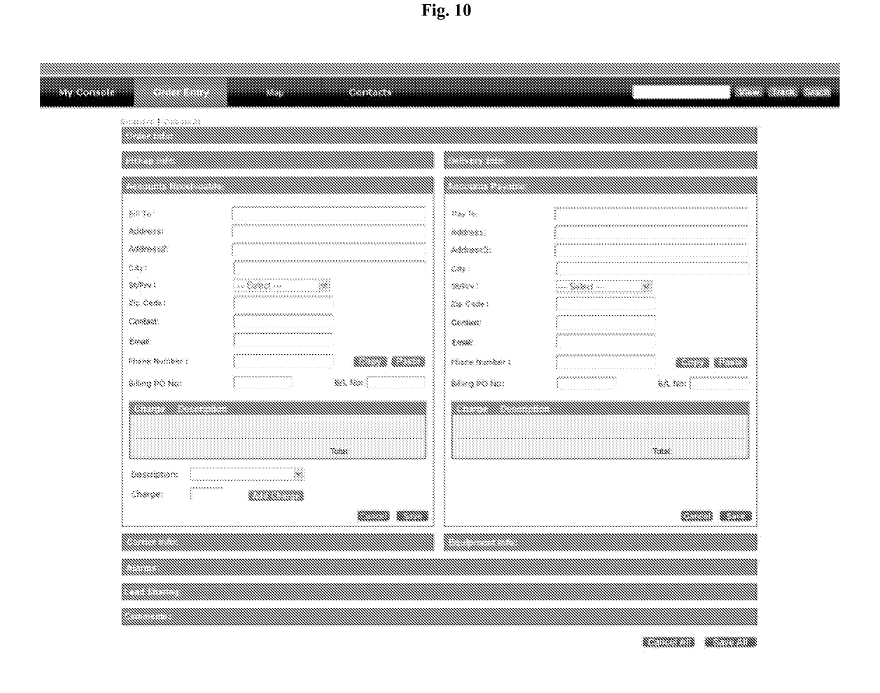

Referring to FIG. 10, in a particular embodiment, a user console display optionally provides tools for creation of a new order. In this embodiment, new order creation tools include a GUI for entering accounts receivable and accounts payable information for a new order.

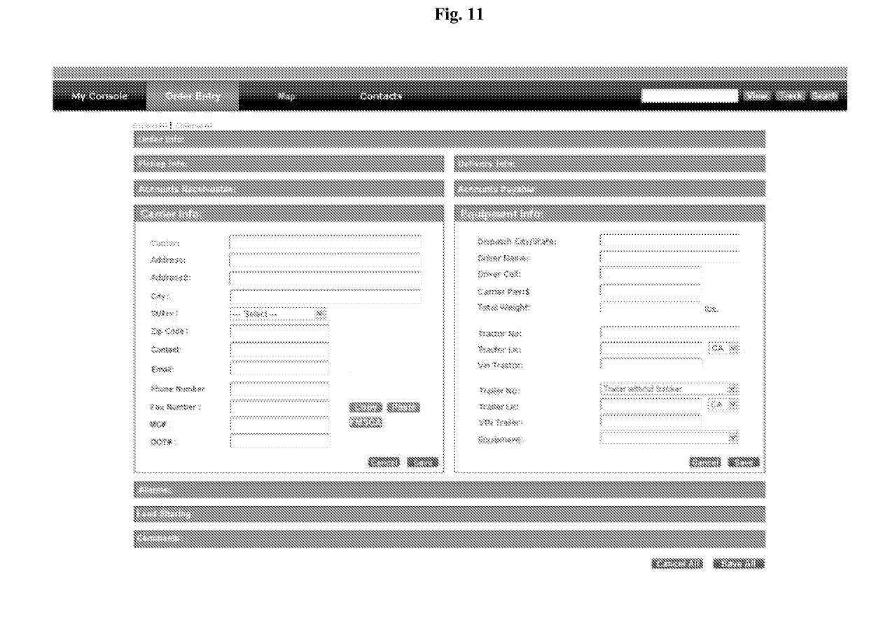

Referring to FIG. 11, in a particular embodiment, a user console display optionally provides tools for creation of a new order. In this embodiment, new order creation tools include a GUI for entering carrier and equipment information for a new order. Further, in this embodiment, equipment information includes driver name, driver phone number, carrier pay rate, total weight, tractor number, license, and VIN, and trailer number, license, and VIN.

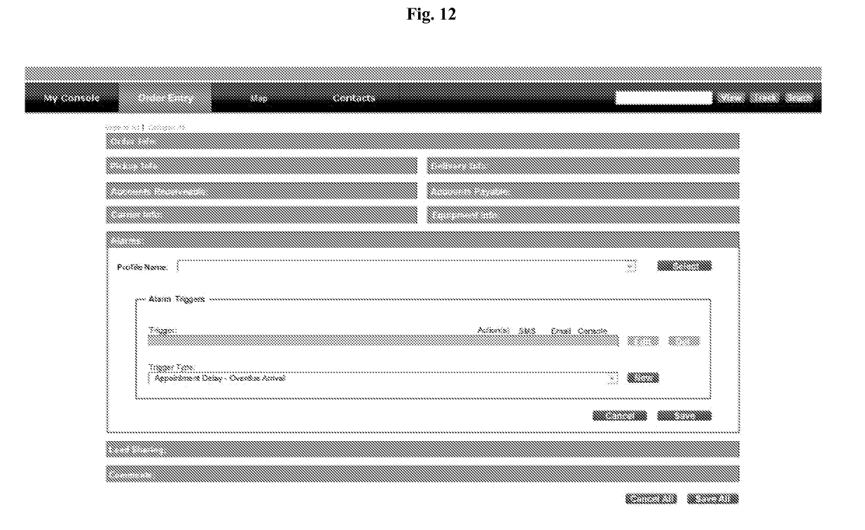

Referring to FIG. 12, in a particular embodiment, a user console display optionally provides tools for creation of a new order. In this embodiment, new order creation tools include a GUI for configuring alarms for a new order such as alarms triggered by delay, deviation from planned course, deviation from required freight conditions, and the like.

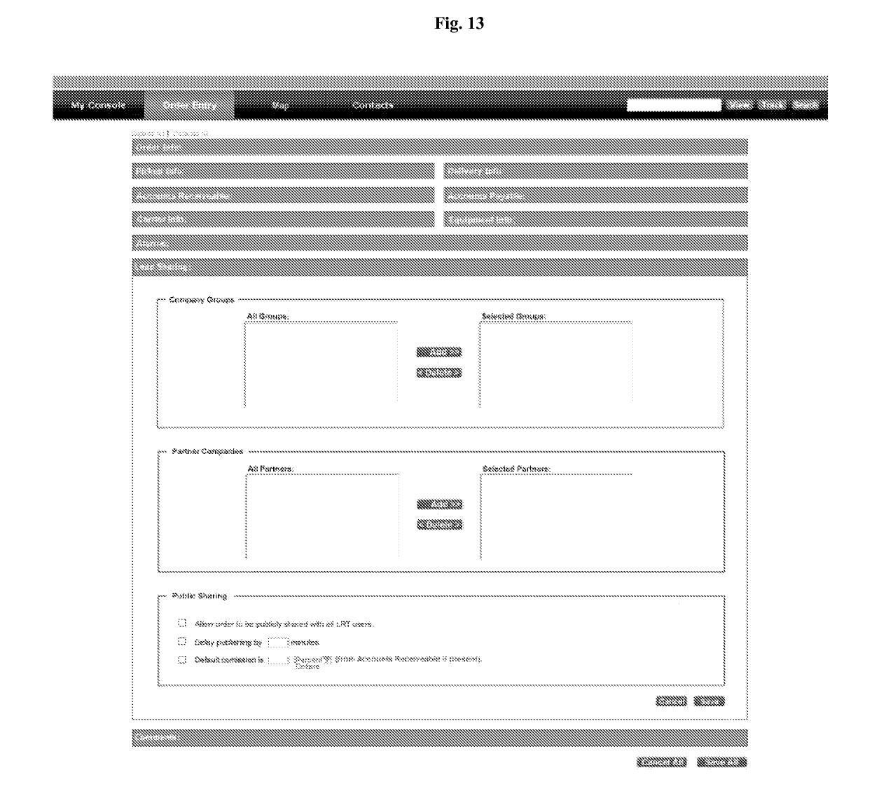

Referring to FIG. 13, in a particular embodiment, a user console display optionally provides tools for creation of a new order. In this embodiment, new order creation tools include a GUI for entering load sharing information for a new order.

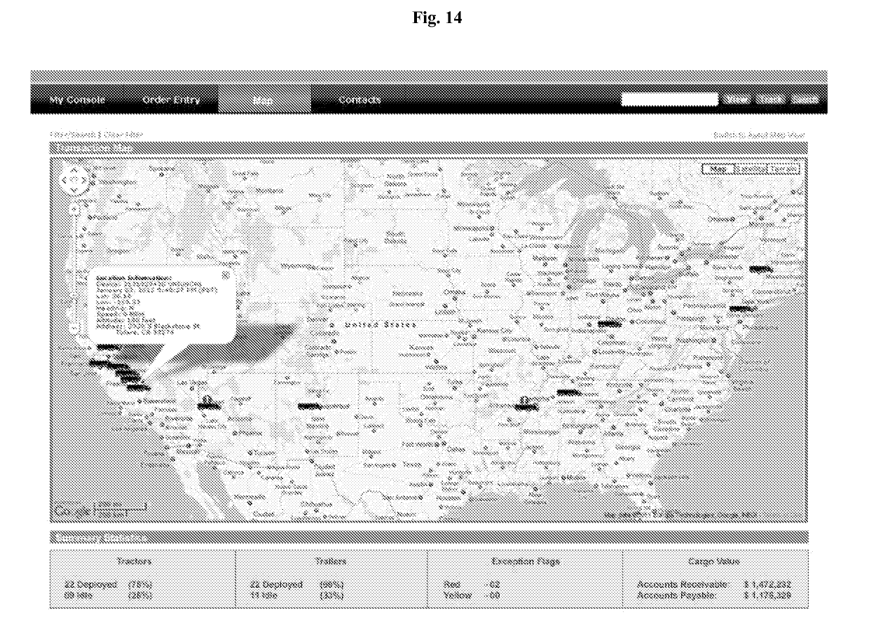

Referring to FIG. 14, in a particular embodiment, a user console display provides information on a plurality of orders. In this embodiment, a user console display provides telemetry data displayed on a map as a breadcrumb trail for a plurality of orders.

### Virtual Communities

In some embodiments, the platforms, systems, applications, and methods described herein include virtual communities, or use of the same. In further embodiments, the virtual communities disclosed herein comprise networks of user-created partnerships. In still further embodiments, a partnership is created by an electronic request triggered by a first user (e.g., a partnership request, a partnership invitation, etc.) followed by an acknowledgement to the request triggered by a second user (e.g., a request or invitation acceptance). Partnerships are suitably formed between many types of users. In various embodiments, a partnership is suitably formed between any of: shippers, carriers, brokers, transport equipment owners, transport equipment operators, receivers, insurers, or factoring companies.

In some embodiments, the virtual communities disclosed herein are used to create and display partnership-based activity feeds via computer-implemented methods comprising the steps of monitoring a plurality of activities in an environment for providing freight transportation information; storing the plurality of activities in a database; generating a feed of the activities, the feed for presentation to at least one viewing user and relating to one or more activities performed by another user; limiting access to the feed to provide a set of viewing users; and displaying the feed to at least one viewing user of the set of viewing users.

In some embodiments, an activity feed disclosed herein displays a user's activities within a transportation management system, a procurement system, or a load board to the user's partners. In some embodiments, an activity feed disclosed herein allows a user to monitor activities the user's partners within a transportation management system, a procurement system, or a load board. Many types of activities are suitably displayed and/or monitored via an activity feed including, by way of non-limiting examples, posting availability of freight transport equipment, posting availability of freight in need of transport, viewing an availability post, associating freight information with freight transport equipment information to form an order, and viewing an order.

In some embodiments, activities in a feed are limited based on the existence of a partnership between the performing user and the viewing user. In further embodiments, activities in a feed are permanently limited to a set of predetermined of viewing users (e.g., based on the existence of a partnership between the performing user and the viewing user). In other embodiments, activities in a feed are temporarily limited to a set of predetermined of viewing users (e.g., based on the existence of a partnership between the performing user and the viewing user). In further embodiments, access to each activity in an activity feed is unlimited after a delay period (e.g., available to all users regardless of existence of a partnership). Many time intervals are suitable for a delay period described herein. In various embodiments, suitable delay periods include, by way of non-limiting examples, at least 1 minute, 2, minutes, 3 minutes, 4 minutes, 5 minutes, 10 minutes, 15 minutes, 20 minutes, 25 minutes, 30 minutes, 1 hour, 2 hours, 3 hours, 4 hours, 5 hours, 6 hours, 12 hours, 1 day, 2 days, 3 days, 4 days, 5 days, 6 days, and 1 week, including increments therein. In some embodiments, the delay period is user configurable. In light of the disclosure provided herein, those of skill in the art will recognize that a delay period allows a user's partners to view their activity before other users.

In some embodiments, the platforms, systems, applications, and methods described herein include a software module for creating and managing partnerships. In further embodiments, a software module for creating and managing partnerships provides a GUI offering access to partnership management tools and features. In still further embodiments, managing partnerships involves, by way of non-limiting examples, sending invitations to partner, responding to invitations to partner, viewing partnerships, viewing permission settings for individual partners and/or groups of partners, configuring permission settings for individual partners and/or groups of partners, and the like. In a particular embodiment, managing partnerships involves customizing an activity feed based on the activities of individual partners.

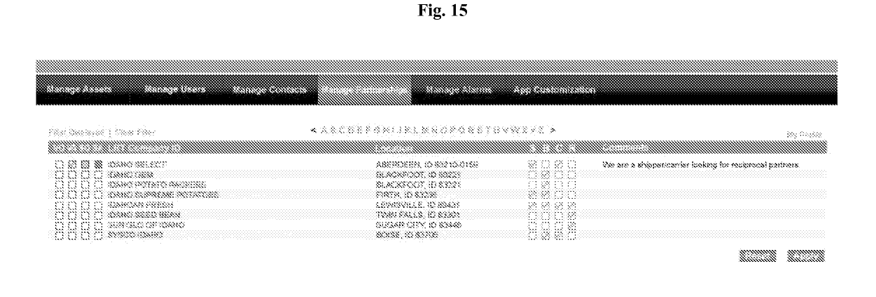

Referring to FIG. 15, in a particular embodiment, a software module for managing partnerships provides a GUI including tools for viewing permissions allowing partners to view posted orders (e.g., availability posts and/or created orders) or assets (e.g., freight transport equipment) and/or permissions for partners to be shown posted orders or assets. In this embodiment, each partner is optionally configured to view posted orders (e.g., activity posted by the configuring user), view posted assets, share posted orders (e.g., allowing the configuring user to see activity posted by the partner), and/or share posted assets.

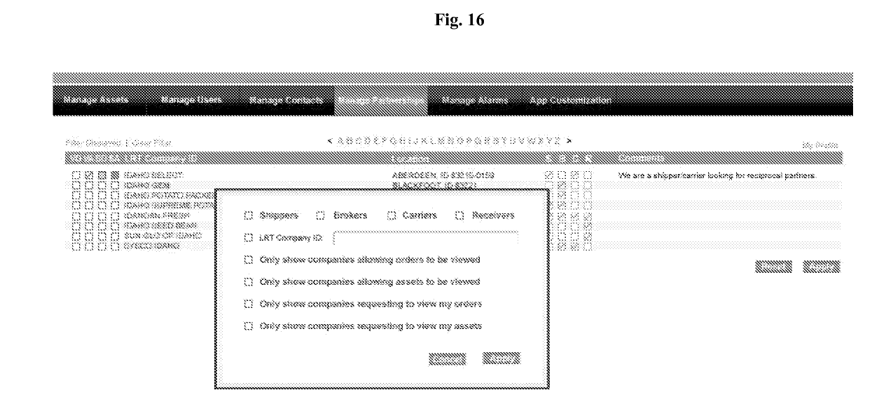

Referring to FIG. 16, in a particular embodiment, a software module for managing partnerships provides a GUI including tools for filtering partners based on type, ID, or order/asset sharing status.

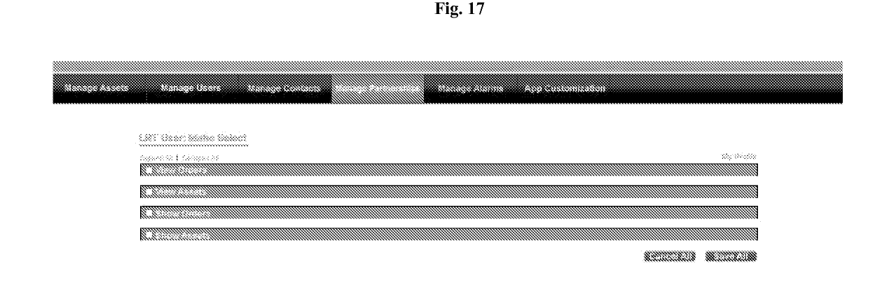

Referring to FIG. 17, in a particular embodiment, a software module for managing partnerships provides a GUI including tools for configuring permissions allowing a partner to view posted orders (e.g., availability posts and/or created orders) or assets (e.g., freight transport equipment) and/or permissions for a partner to share posted orders or assets.

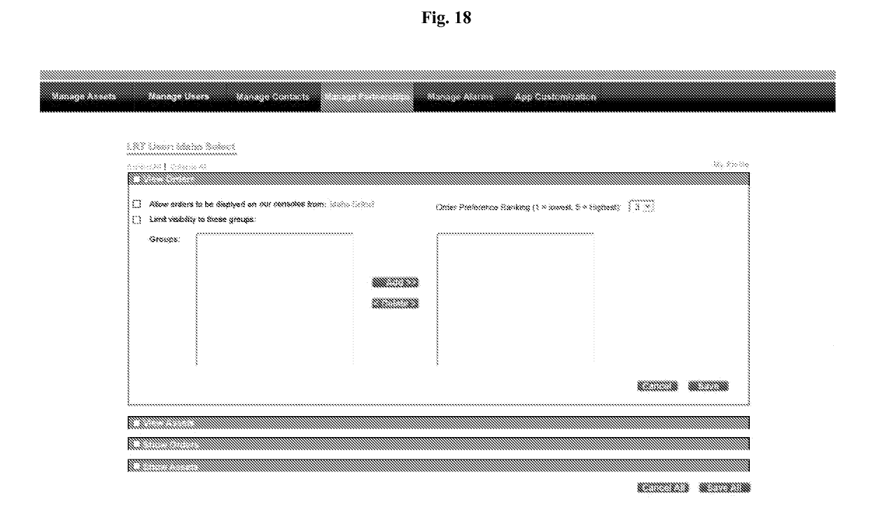

Referring to FIG. 18, in a particular embodiment, a software module for managing partnerships provides a GUI including tools for configuring orders to be viewed from a particular partner.

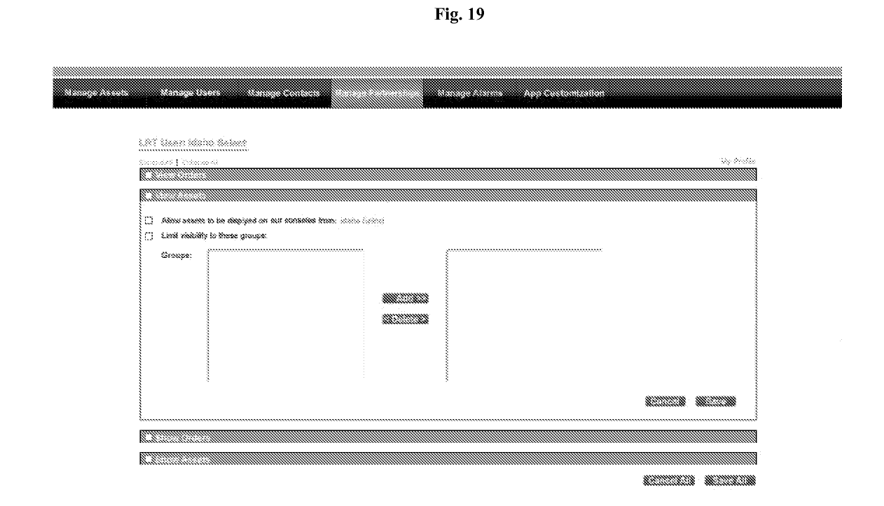

Referring to FIG. 19, in a particular embodiment, a software module for managing partnerships provides a GUI including tools for configuring assets (e.g., freight transport equipment) to be viewed from a particular partner.

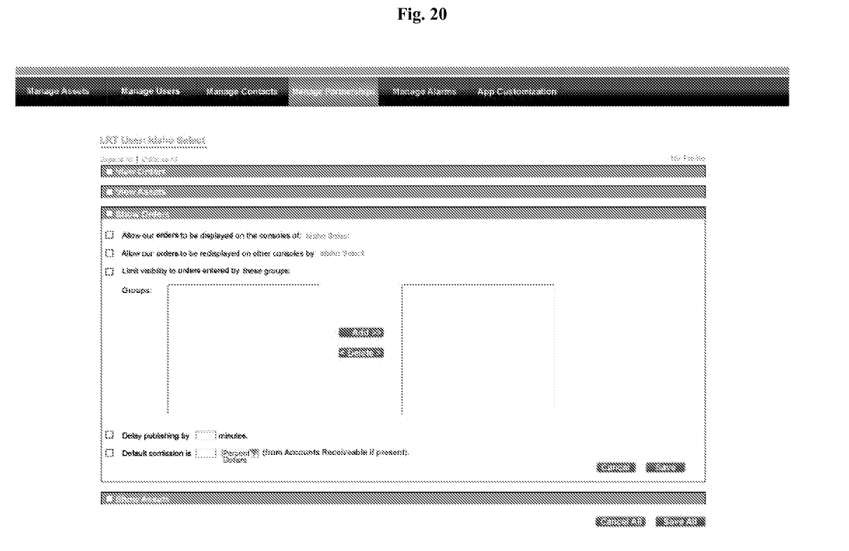

Referring to FIG. 20, in a particular embodiment, a software module for managing partnerships provides a GUI including tools for configuring orders to be shown to a particular partner.

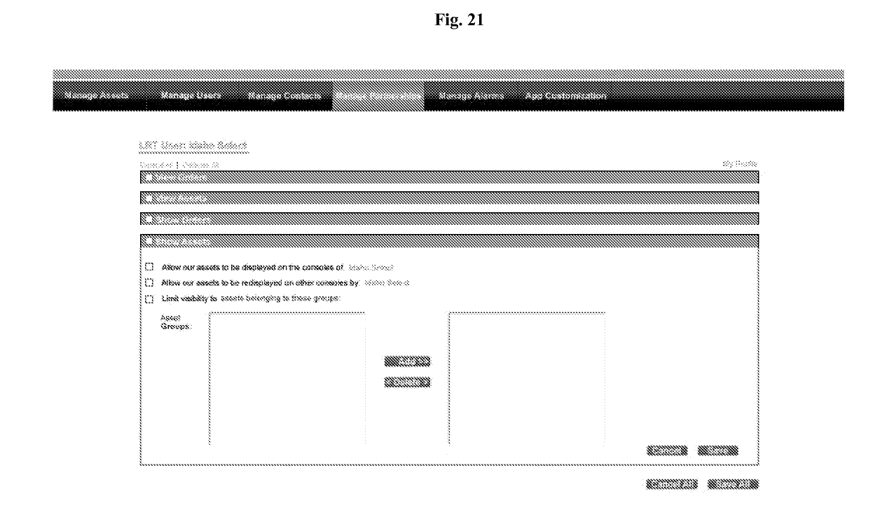

Referring to FIG. 21, in a particular embodiment, a software module for managing partnerships provides a GUI including tools for configuring assets (e.g., freight transport equipment) to be shown to a particular partner.

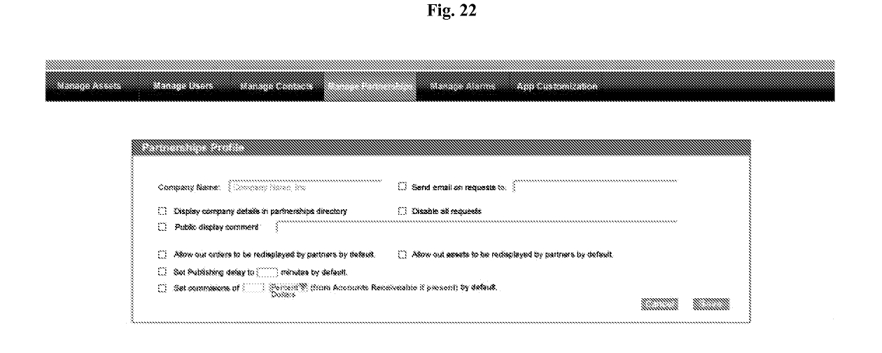

Referring to FIG. 22, in a particular embodiment, a software module for managing partnerships provides a GUI including tools to customize a user's partnership profile.

### Digital Processing Device

In some embodiments, the platforms, systems, applications, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the platforms, systems, applications, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, applications, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, applications, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, applications, and methods disclosed herein include one or more databases, or use of the same. In view of the disclosure provided herein, those of skill in the art will recognize that many databases are suitable for storage and retrieval of freight information, freight transport equipment information, order information, and the like. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following specific examples are to be construed as merely illustrative, and not limitative of the remainder of the disclosure in any way whatsoever. Without further elaboration, it is believed that one skilled in the art can, based on the description herein, utilize the present invention to its fullest extent.

### Example 1

### Establishment of a Load Board Community

A shipper wishes to participate in a load board. The shipper is interested in submitting a job of transporting a large load of potato chips to a load board, but is wary because a previous load he posted on the board was damaged during shipment when the driver of that shipment took an unauthorized route.

To keep better track of his shipment of potato chips, the shipper joins a different, restricted-access load board community, which is a virtual board community comprised of networks of user-created partnerships. The shipper creates his network of partnerships by viewing users of the load board community and sending an invitation to community members that he knows and has worked with in the past. When the community member accepts the invitation, a user-created partnership is created within the shipper's network. The shipper sets his load board membership settings within his console to reflect that his activities are viewable only by those community members in his personal network. The shipper has access to load board posts generated by partners in the shipper's network in the form of an activity feed. The feed can be sorted by type of activity, such as posting availability of freight in need of transport, or viewing available transporters.

### Example 2

### Creation of an Availability Post on a Load Board

The shipper wishes to create an availability post for his potato chips on the load board. To do so, the shipper accesses his user-created network using a web-based interface accessed with a web browser on the shipper's Apple® iPad®. From within his console in his load board account, the shipper provides a description of the freight, the weight of the freight, the location, date, and time for pick up of the freight, the preferred transport route, and the location, date, time for drop-off of the freight, as well as the shipper's requirement that the transporter must have an electronic device in the transportation vehicle for generating and wirelessly transmitting freight transport equipment information, for the purpose of measuring the integrity of the shipment during transport. The shipper indicates on the post when the post is set to expire, and adjusts settings within the application to automatically withdraw the post at the expiration date.

### Example 3

### Accepting a Load Posted on a Load Board

Later that day, a load board community trucker within the shipper's network sees the shipper's availability post on the load board by accessing the trucker's activity feed using an application on the trucker's Samsung® mobile phone. The trucker contacts the shipper to let the shipper know that he is already driving along the shipper's requested route for another job, that he has room in his semi for the shipper's potato chips, and that he will be in the pick-up location at the specified time. Further, the trucker gives the shipper access to his electronic device located in the trucker's semi-trailer truck. After verifying the trucker's information via the information sent by the electronic device, the shipper removes the availability post on the load board and creates an order, indicating the potato chip shipment is now associated with the trucker's transportation equipment. The order appears in both the shipper and trucker's consoles within the load board network. The order details the freight information, and freight transportation equipment for the job, permissible environmental parameters, the agreed-upon route, as well as the billing information for the job.

### Example 4

### Tracking the Load

Once the trucker picks up the potato chip shipment, the shipper optionally accesses information from his console, sent from the electronic device within the trucker's equipment. The information provided is updated continuously, so that the shipper can monitor, substantially in real time, the integrity of the shipment, for example, the temperature, atmospheric pressure, shock, and opening and closing of the semi-trailer's doors. Further, the shipper can monitor the shipment's location through the electronic device's GPS chip and cellular modem. The shipper can adjust the settings within his console to record chosen parameters for later viewing. The shipper can further adjust the settings within his console to alert the shipper by text message if the trucker's electronic device reports the environmental conditions or shipment location outside the parameters of the order agreement.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented method comprising the steps of:
a. monitoring, by a processor, a plurality of activities in an environment for providing freight transportation information;
b. storing, by the processor, the plurality of activities in a database;
c. generating, by the processor, a feed of the activities, the feed for presentation to at least one viewing user and relating to one or more activities performed by another user;
d. limiting access, by the processor, to the feed to provide a set of viewing users; and
e. displaying, by the processor, the feed to at least one viewing user of the set of viewing users.

2. The method of claim 1, wherein the environment for providing freight transportation information comprises: a transportation management system, a procurement system, or a load board.

3. The method of claim 1, wherein the activities comprise posts indicating the availability of freight transport equipment.

4. The method of claim 3, wherein the posts indicating the availability of freight transport equipment comprise freight transport equipment information derived directly and automatically from an electronic device physically connected to the freight transport equipment.

5. (canceled)

6. (canceled)

7. (canceled)

8. The method of claim 1, wherein limiting access is based on the existence of a partnership between the performing user and the viewing user.

9. (canceled)

10. (canceled)

11. (canceled)

12. (canceled)

13. (canceled)

14. (canceled)

15. (canceled)

16. A non-transitory computer-readable storage media encoded with a computer program including instructions executable by a processor to create a load board application, the application comprising:
a. a software module configured to allow creation of an availability post, the availability post comprising freight transport equipment information or freight information;
b. a software module configured to allow creation of an order, the order comprising freight transport equipment information associated with freight information; and
c. a software module configured to provide a user console display, the display comprising availability posts and orders;
provided that the freight transport equipment information comprises information derived directly and automatically from an electronic device physically connected to the freight transport equipment.

17. The media of claim 16, wherein the electronic device physically connected to the freight transport equipment comprises a GPS chip and cellular modem.

18. The media of claim 16, wherein the freight transport equipment is a: tractor, trailer, shipping container, rail car, aircraft, or watercraft.

19. The media of claim 16, wherein the freight transport equipment information comprises: location and load status.

20. The media of claim 19, wherein the freight transport equipment information comprises: type of freight transport equipment, operator, and carrier.

21. (canceled)

22. (canceled)

23. The media of claim 16, wherein each order displayed by the user console display comprises freight transport equipment information including one or more of: telemetry information and freight integrity information.

24. The media of claim 23, wherein the telemetry information comprises at least one of: location, speed, direction, and altitude.

25. The media of claim 24, wherein the telemetry information is displayed on a map.

26. (canceled)

27. (canceled)

28. (canceled)

29. The media of claim 16, wherein the application further comprises a software module configured to allow creation of partnerships between users, a partnership created by an electronic request followed by an acknowledgement.

30. The media of claim 29, wherein a partnership is between one or more of: a shipper, a carrier, a broker, a transport equipment owner, a transport equipment operator, a receiver, an insurer, and a factoring company.

31. The media of claim 29, wherein the user console display comprises tools to sort or filter availability posts and orders based on one or more created partnerships.

32. The media of claim 29, wherein created availability posts are optionally displayed first to partners and subsequently to non-partners after passage of a delay period.

33. (canceled)

34. The media of claim 16, wherein the module configured to allow creation of an availability post assigns a level of data authenticity.

35. The media of claim 34, wherein the level of data authenticity is based on method of installation of the electronic device physically connected to the freight transport equipment.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. A data authenticated load board platform comprising:
a. a plurality of electronic devices, each device physically connected to a piece of freight transport equipment, each device configured to transmit freight transport equipment information to a load board application; and
b. a server comprising a processor configured to provide a load board application, the application comprising:
i. a software module configured to allow creation of an availability post, the availability post comprising the transmitted freight transport equipment information or freight information;
ii. a software module configured to allow creation of an order, the order comprising the transmitted freight transport equipment information associated with freight information; and
iii. a software module configured to provide a user console display, the display comprising availability posts and orders.
